(19) United States
(12) Patent Application Publication
(10) Pub. No.: US 2014/0056447 A1
(43) Pub. Date: Feb. 27, 2014

(54) Speaker

(71) Applicants: Lin-Zhen Li, Shenzhen (CN); Xiong Zhang, Shenzhen (CN)

(72) Inventors: Lin-Zhen Li, Shenzhen (CN); Xiong Zhang, Shenzhen (CN)

(73) Assignees: AAC ACOUSTIC TECHNOLOGIES (CHANGZHOU) CO., LTD., Changzhou (CN); AAC ACOUSTIC TECHNOLOGIES (SHENZHEN) CO., LTD., Shenzhen (CN)

(21) Appl. No.: 14/010,658

(22) Filed: Aug. 27, 2013

(30) Foreign Application Priority Data
Aug. 27, 2012 (CN) 201220429846.3

(51) Int. Cl. H04R 1/00

(52) U.S. Cl. CPC H04R 1/00
USPC 381/162

(57) ABSTRACT

A speaker includes a vibrating unit, a gasket and a magnetic circuit unit. The vibrating unit includes a diaphragm, and a voice coil electrically connecting to the elastic plate. The gasket supporting the position portion of the diaphragm includes a number of slots serving as air leaking holes for communicating interior of the speaker with exterior space. The combination of the diaphragm and the gasket is mounted to and positioned by the magnetic circuit unit. A projection of the diaphragm on the magnetic circuit unit is disposed within an outline of the magnetic circuit unit. The speaker has no frame or any structure with a frame configuration, which makes the magnetic circuit unit larger and more powerful.

### FIELD OF THE DISCLOSURE

The present disclosure relates to the art of speakers, particularly to a micro-speaker used in an electronic device.

### DESCRIPTION OF RELATED ART

Micro-speakers have been widely used in portable electronic devices, such as cellular phones, notebooks, and so on. With the continuing development of the portable electronic devices, people request for more and more functions with audible sensations, which brings a rapid development of the technologies of micro-speakers.

A related micro-speaker includes a frame, a vibrating unit and a magnetic circuit unit attached to the frame. The vibrating unit includes a diaphragm attached to the frame, and a voice coil for driving the diaphragm to vibrate. The magnetic circuit unit includes a yoke positioned to the frame and a magnet disposed in the yoke. Generally, when the micro-speaker works, air in the micro-speaker will be compressed and expanded which would badly affect the sensitivity of the micro-speaker.

The frame is used to accommodate the magnetic circuit unit, and to support the diaphragm and the terminals. However, the frame of the related micro-speaker takes a lot of space, which makes the magnetic circuit unit have a small size and the micro-speaker have a low sensitivity.

Therefore, it is desirable to provide a speaker which can overcome the above-mentioned problems.

### BRIEF DESCRIPTION OF THE DRAWINGS

Many aspects of the embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric view of a speaker in accordance with a first embodiment of the present disclosure.

FIG. 2 is an exploded view of the speaker of FIG. 1.

FIG. 3 is a cross-sectional view of the speaker taken along line III-III of FIG. 1.

FIG. 4 is partially assembled view of the speaker in accordance with the first embodiment of the present disclosure.

FIG. 5 is partially assembled view of a speaker in accordance with a second embodiment of the present disclosure.

FIG. 6 is partially assembled view of a speaker in accordance with a third embodiment of the present disclosure.

FIG. 7 is an exploded view of a magnetic circuit unit of the speaker in accordance with the first embodiment of the present disclosure.

FIG. 8 is an exploded view of a magnetic circuit unit of a speaker in accordance with a forth embodiment of the present disclosure.

FIG. 9 is an exploded view of a magnetic circuit unit of a speaker in accordance with a fifth embodiment of the present disclosure.

### DETAILED DESCRIPTION OF THE EMBODIMENTS

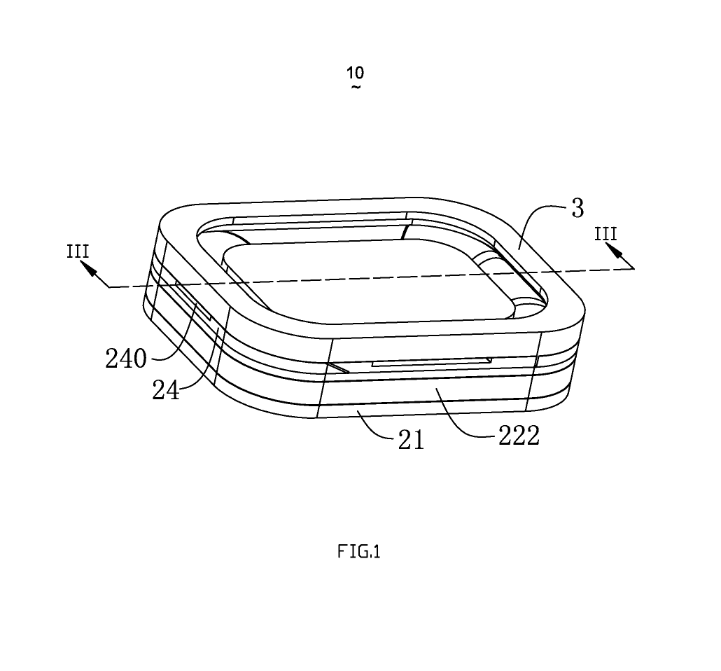

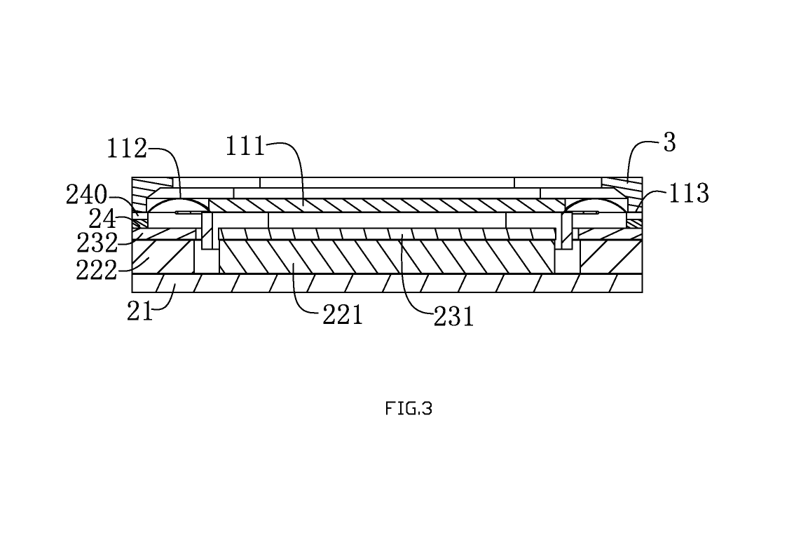

Referring to FIGS. 1-3, a speaker 10 in accordance with a first embodiment of the present disclosure, includes a vibration unit 1 and a magnetic circuit unit 2. The vibration unit 1 includes a diaphragm 11, a voice coil 12 capable of driving the diaphragm 11 to vibrate along a vibration direction. The diaphragm 11 includes a flat central portion 111, a curved portion 112 extending from the central portion 111 and surrounding around the flat central portion 111, and a position portion 1113 disposed at an edge of the diaphragm 111. In other embodiment, the diaphragm 11 could also include a top plate attached on the flat central portion 111.

The magnetic circuit unit 2 includes a base board 21, a first magnetic conduction member 221 disposed at a center portion of the base board 21, a second magnetic conduction member 222 disposed at a periphery portion of the base board 21 for forming a magnetic gap with the first magnetic conduction member 221. At least one of the first and second magnetic conduction members 221,222 is a permanent magnet. In this embodiment, the second magnetic conduction member 222 is an integrated ring-shaped configuration without gaps. In other embodiment, a plurality of separated second magnetic conduction members 222 is provided to surround the first magnetic conduction member 221. Each two adjacent second magnetic conduction member 222 forms a gap therebetween. The voice coil 12 has one end accommodated in the magnetic gap and the other end connected with the diaphragm 11.

The magnetic circuit unit is a necessary component or combination of a plurality of components used in an electro-acoustic device. The magnetic circuit unit is used to provide a closed loop of a magnetic field, and is formed by magnetic conduction materials. In this embodiment, the magnetic circuit unit 2 further includes a first pole plate 231 attached on a top face of the first magnetic conduction member 221 and a ring-shaped second pole plate 232 attached on a top face of the second magnetic conduction member 222. The shape of the second pole plate 232 is not restricted to the ring as described in this embodiment. Alternatively, the second pole plate 232 may be a rectangular plate corresponding to each of the second magnetic conduction members 222. While electrified, the voice coil 12 drives the diaphragm 11 to vibrate along a vibration direction by the interaction between the voice coil 12 and the magnetic circuit unit 2. Generally, the vibration direction is perpendicular to the base board 21.

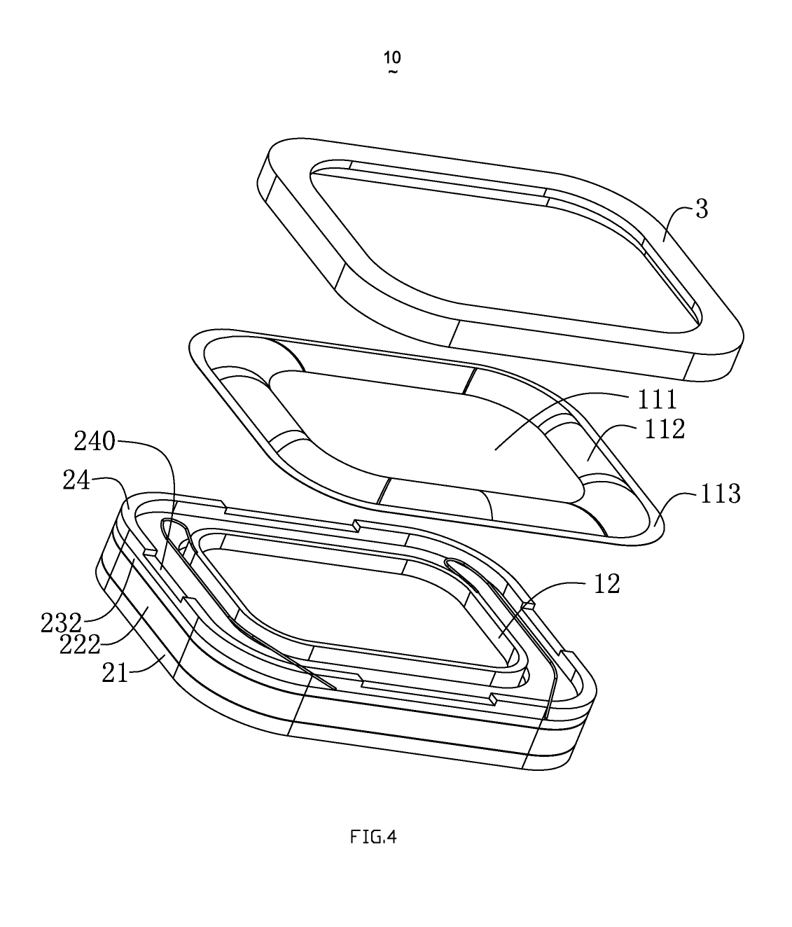

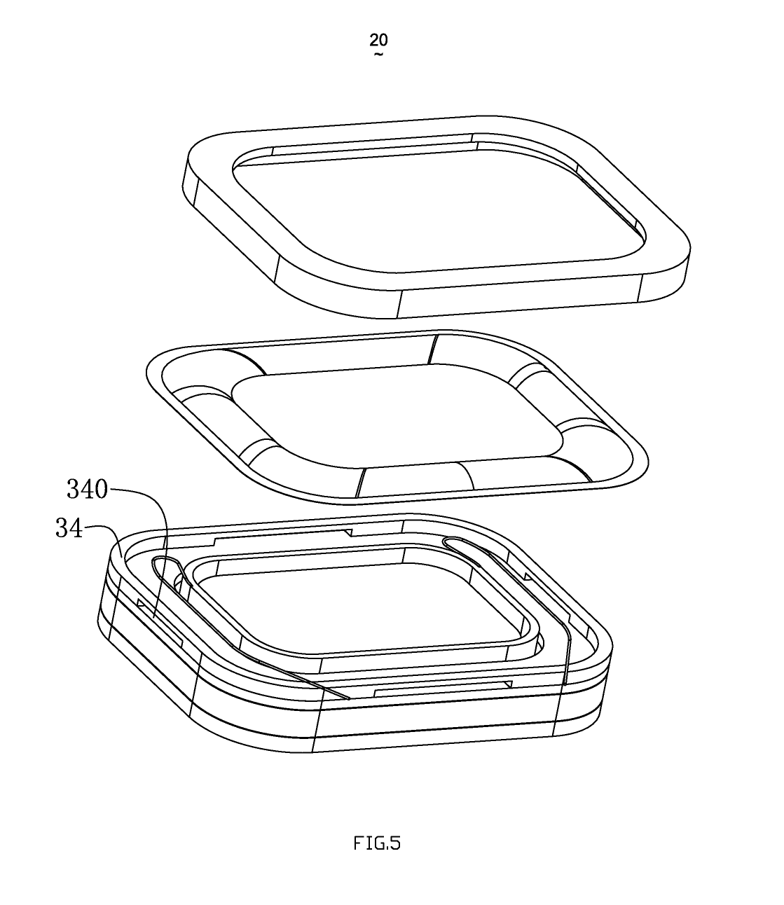

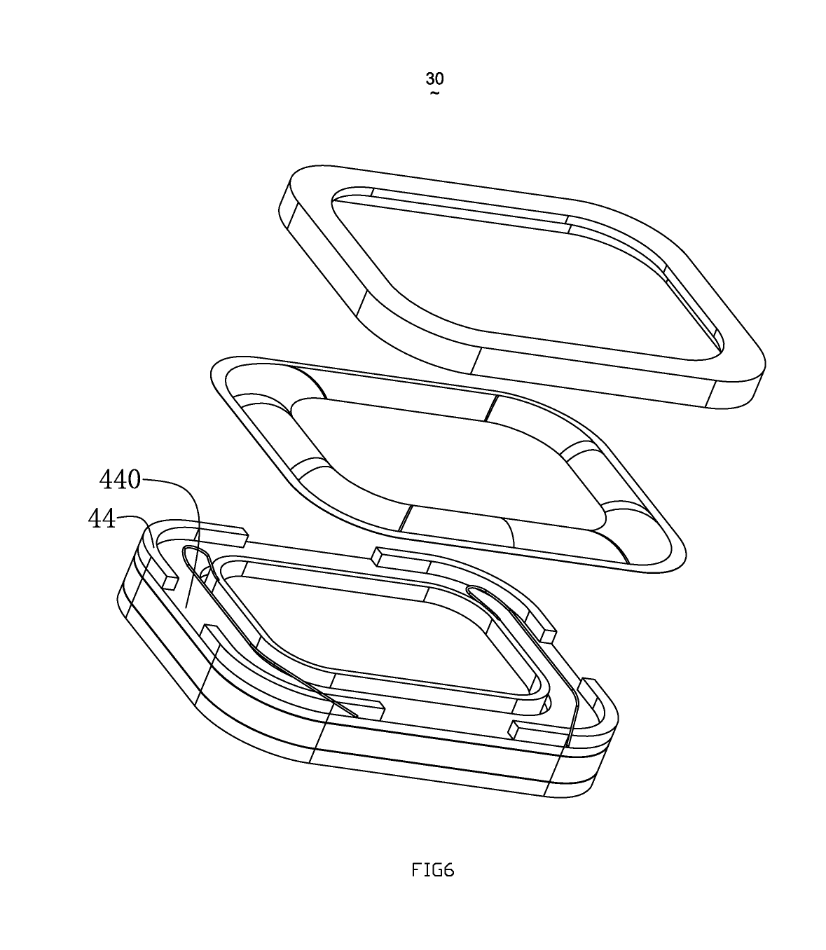

Referring to FIGS. 1-4, particularly to FIG. 4, a gasket 24 is attached on the second pole plate 232. The vibrating unit 1 is connected to the magnetic circuit unit 2 with the position portion 113 of the diaphragm 11 positioned on a top face of the gasket 24. In this embodiment, the gasket 24 which has a ring-shaped configuration is disposed between the position portion 113 of the diaphragm 11 and the second pole plate 232, so the gasket 24 is mounted on the second pole plate 232. In addition, the gasket 24 includes a plurality of slots 240 serving as air leaking holes for communicating interior of the speaker 10 with exterior space thereof. The slots 240 are depressed from a top face of the gasket 24. Referring to FIG. 5, a speaker 20, in accordance with a second embodiment of the present disclosure, has a plurality of slots 340 depressed from a bottom face of the gasket 34. Referring to FIG. 6, a speaker 30 in accordance with a third embodiment of the present disclosure, has a plurality of separated gaskets 44, the gasket 44 has a L-shaped configuration, each two adjacent gaskets 44 forming a gap 440 serving as an air leaking hole. Alternatively, the slot could be a hole passing through the gasket. The amount, shape and position of the leakage hole in the gasket may be adjusted or changed according to the requirements of design, manufacturing, or individual user.

The curved portion 1112 of the diaphragm 11 is disposed above the second pole plate 232. A projection of the diaphragm 11 on the base board 21 along the vibration direction of the diaphragm 11 is within an outline of the base board 21. Compared with the related art, the diaphragm is supported by the magnetic circuit unit, and the voice coil is accommodated in the space formed by the diaphragm and the magnetic unit, which configuration omits the frame used in related art. In addition, if provided with a same size to the related art, the magnetic circuit unit could be enlarged for providing improved performance.

Optionally, the speaker 10 further includes a front cover 3 attached to the vibrating unit 1 and the magnetic circuit unit 2. The front cover 3 has an acoustic hole 31 for emitting sounds generated by the diaphragm 11. In addition, the front cover 3 presses on the position portion 113 of the diaphragm 11 for fixing the diaphragm 11 on the gasket 24.

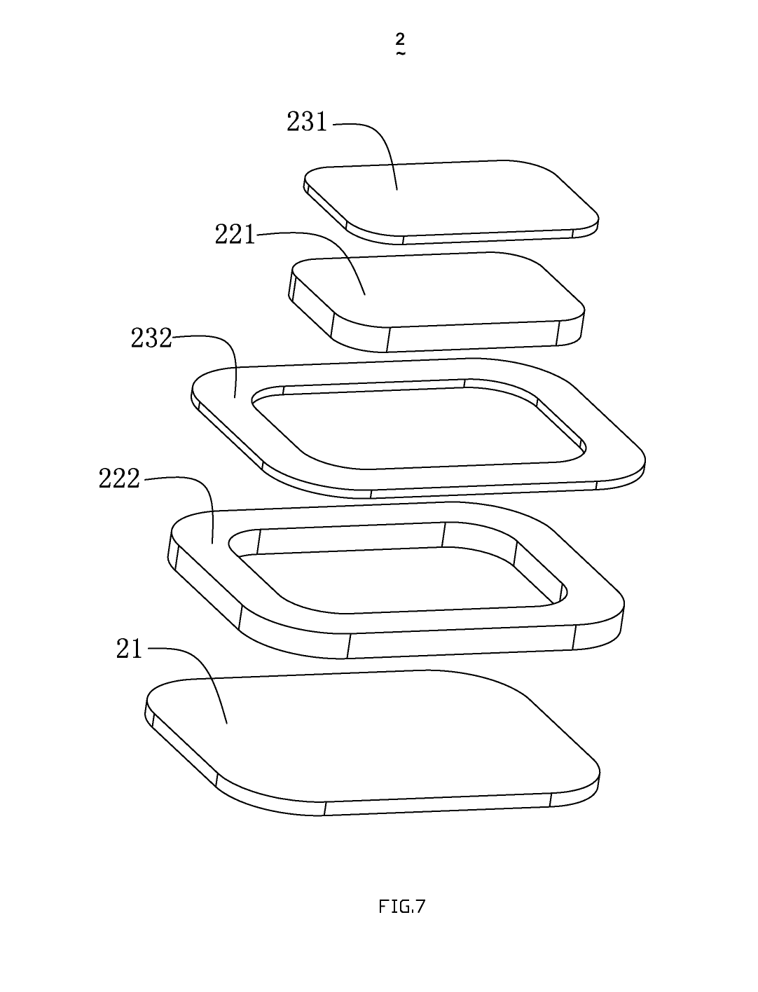

FIG. 7 illustrates the magnetic circuit unit 2 of the speaker 10 in accordance with the first embodiment of the present disclosure, in which both the first magnetic conduction member 221 and the second magnetic conduction member 222 are permanent magnets. The second magnetic conduction member 222 may be a ring surrounding the first magnetic conduction member 221. Optionally, the second magnetic conduction member 222 may be a plurality of separated pieces arranged around the first magnetic conduction member 221. The magnetic circuit unit 2 is used to provide a magnetic gap and to support the combination of the gasket 24 and diaphragm 11, no matter how the first or second magnetic conduction member 221, 222 is configured.

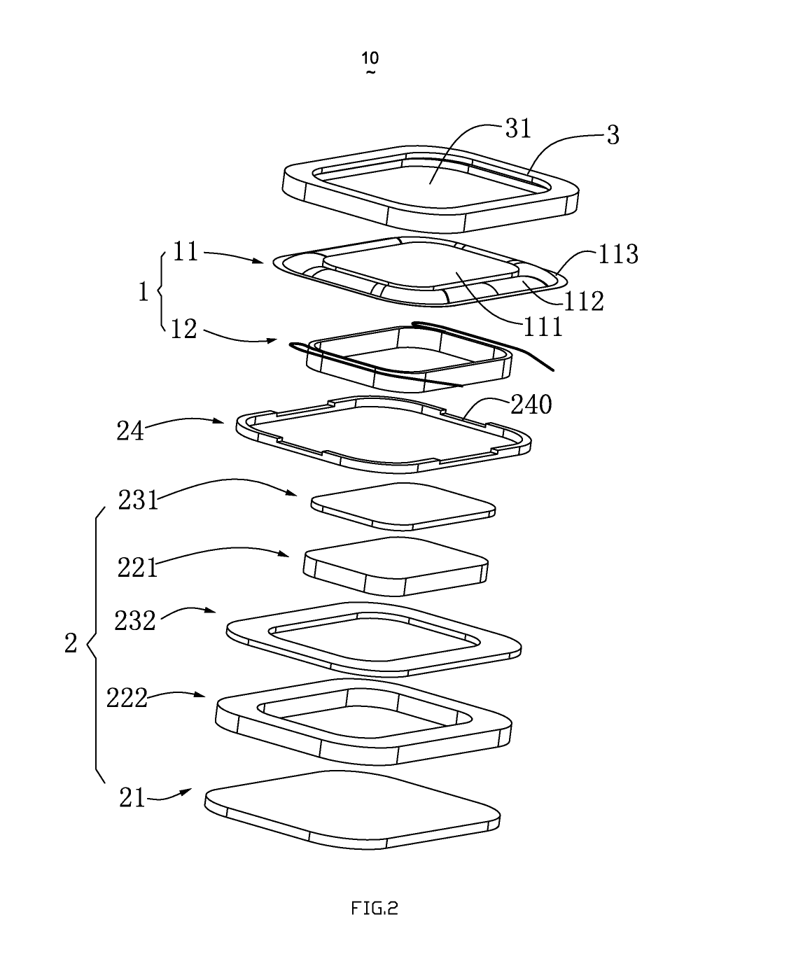

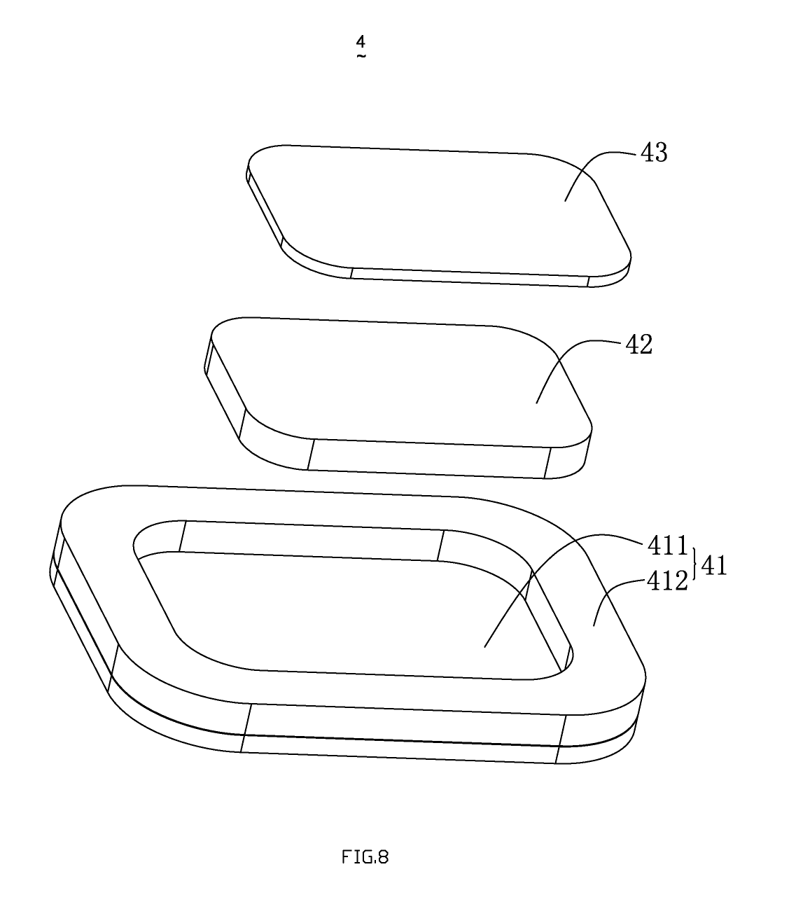

Referring to FIG. 8, a magnetic circuit unit 4 of a speaker in accordance with a forth embodiment of the present disclosure, includes a bowl-shaped yoke 41 with a bottom wall 411 and a sidewall 412 extending upwards from an edge of the bottom wall 411, a magnet 42 disposed within the yoke 41, and a pole plate 43 attached on the magnet 42. The magnet 42 is a permanent magnet. In this embodiment, the gasket 24 (shown in FIGS. 2-4) could be connected to a top face of the sidewall 412. And, for enlarging the vibration space of the diaphragm 11, the gasket 24 is optionally higher than the pole plate 43.

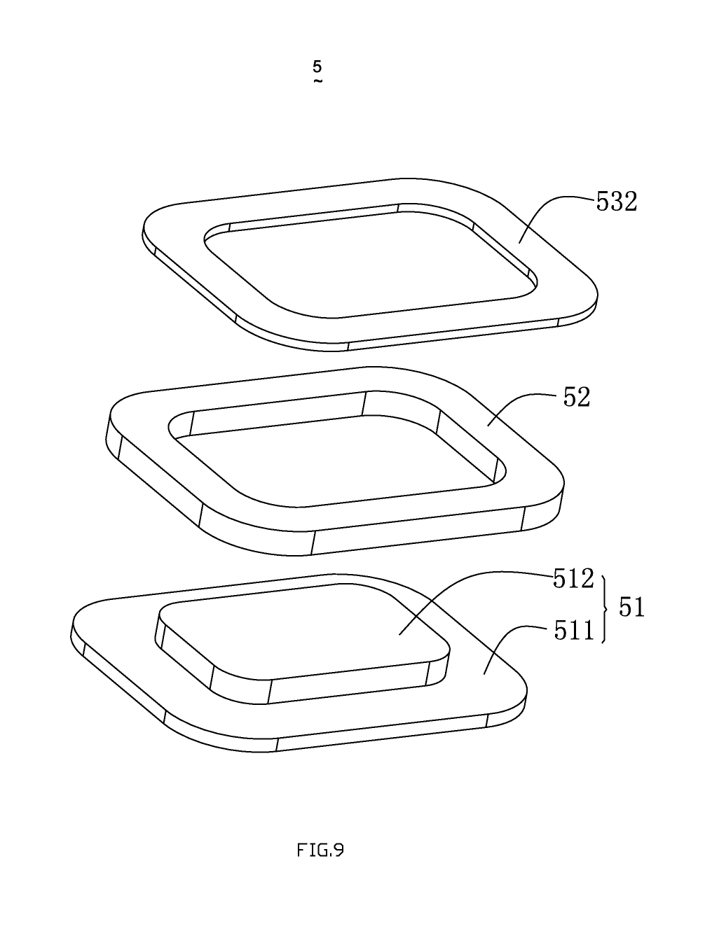

Referring to FIG. 9, the magnetic circuit unit 5 of a fourth embodiment, includes a T-shaped yoke 51 including a bottom wall 511 and a side wall 512 extending upwards from an central portion of the bottom wall 511, a permanent magnet 52 attached to the bottom wall 511, and an inner pole plate 531 attached to the side wall 512. The magnet 52 may be a ring surrounding the side wall 512. Optionally, the magnet may be a plurality of separated pieces arranged around the side wall 512, for providing a magnetic gap together with the side wall 512.

According to the embodiments described above, the position portion of diaphragm could be indirectly connected to the outer pole plate via a gasket with a top face of the gasket higher than that of the inner pole plate. A greater space for vibration of the diaphragm is optional and preferable. A projection of the diaphragm along the vibration direction on the bottom wall is not larger than the bottom wall, by which the speaker is provided with smaller size, or is provided with enlarged magnetic circuit unit. Sound quality of the speaker having such a configuration is accordingly improved. In addition, the gasket includes a plurality of slots serving as air leaking holes for communicating interior of the speaker with exterior space thereof. In such situation, when the speaker works, expanded air in the speaker can be leaked to the outside of the speaker through the slots so as to protect the speaker.

The embodiments described above may be summarized as follows. A speaker includes a magnetic circuit unit, a diaphragm connected to the magnetic circuit unit, a voice coil for driving the diaphragm to vibrate along a vibration direction, and a gasket located on the magnetic circuit unit to support the diaphragm. The magnetic circuit unit includes an inner part, an outer part, and a magnetic gap formed between the inner part and the outer part. The voice coil is partially received and capable of vibrating in the magnetic gap. One of the inner part and the outer part of the magnetic circuit unit is a magnet.

A combination of the gasket and an edge of the diaphragm is connected to the outer part of the magnetic circuit unit. By virtue of such a configuration, a projection of the diaphragm along the vibration direction on the magnetic circuit unit is located within the boundary of the magnetic circuit unit, thereby omitting a frame used in the related art for supporting the diaphragm and the magnetic circuit unit. As the frame used in the related art is omitted by this disclosure, an outer side of the speaker is formed by the outer part of the magnetic circuit unit and the edge of the diaphragm. For enlarging a vibration space of the diaphragm, the diaphragm connects to the outer part via a gasket attaching to the top of the outer part.

It will be understood that the above-mentioned particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A speaker, comprising:
a vibrating unit, including a diaphragm, and a voice coil driving the diaphragm to vibrate along a vibration direction, the diaphragm including a position portion serving as an edge of the diaphragm;
a gasket supporting the position portion of the diaphragm, the gasket including a plurality of slots serving as air leaking holes for communicating interior of the speaker with exterior space thereof;
a magnetic circuit unit supporting a combination of the diaphragm and the gasket, including a base board, a first magnetic conduction member disposed at a central portion of the base board, a second magnetic conduction member around the first magnetic conduction member, and a magnetic gap formed by the first and second magnetic conduction members;
a projection of the diaphragm along the vibration direction on the base board being within an outline of the base board.

2. The speaker as claimed in claim 1, wherein the gasket has a ring-shaped configuration, and the slots are depressed from a top face of the gasket.

3. The speaker as claimed in claim 1, wherein the gasket has a ring-shaped configuration, and the slots are depressed from a bottom face of the gasket.

4. The speaker as claimed in claim 1 including a plurality of separated gaskets, each two adjacent gaskets forming a gap serving as the slot.

5. The speaker as claimed in claim 1, wherein the magnetic circuit unit includes a first pole plate attached on the first magnetic conduction member, and a second pole plate attached on the second magnetic conduction member.

6. The speaker as claimed in claim 1, wherein the second magnetic conduction member is ring-shaped.

7. The speaker as claimed in claim 5, wherein the gasket is disposed between the position portion of the diaphragm and the second pole plate.

8. The speaker as claimed in claim 5, wherein a top face of the gasket is higher than that of the first pole plate.

9. A speaker, comprising:
a magnetic circuit unit including an inner part, an outer part, and a magnetic gap formed between the inner part and the outer part, one of the inner part and the outer part including a magnet;
a gasket mounted on and positioned by the outer part of the magnetic circuit unit, the gasket including a plurality of slots serving as air leaking holes for communicating interior of the speaker with exterior space thereof;
a diaphragm including a position portion located on the gasket;
a voice coil connecting to the diaphragm for driving a combination of the diaphragm and the elastic plate to vibrate along a vibration direction.

10. The speaker as described in claim 9 further including a front cover pressing on the edge of the diaphragm to the gasket.

11. The speaker as described in claim 9, wherein the gasket is higher than the inner part of the magnetic circuit unit.

12. The speaker as claimed in claim 9, wherein the gasket has a ring-shaped configuration, and the slots are depressed from a top face of the gasket.

13. The speaker as claimed in claim 9, wherein the gasket has a ring-shaped configuration, and the slots are depressed from a bottom face of the gasket.

14. The speaker as claimed in claim 9 including a plurality of separated gaskets, each two adjacent gasket forming a gap serving as the slot.
